(19) United States
(12) Patent Application Publication
(10) Pub. No.: US 2010/0046104 A1
(43) Pub. Date: Feb. 25, 2010

(54) Vehicle Rear-View Mirror Shifting System Implemented With Aim To Eliminate The Dead Angle

(76) Inventor: Mate Rimac, Samobor (HR)

Correspondence Address: ST. ONGE STEWARD JOHNSTON & REENS, LLC, 986 BEDFORD STREET, STAMFORD, CT, 06905-5619, US

(21) Appl. No.: 12/555,628

(22) Filed: Sep. 8, 2009

Related U.S. Application Data
(63) Continuation of application No. PCT/HR2008/000006, filed on Mar. 4, 2008.

(30) Foreign Application Priority Data
Mar. 6, 2007 (HR) P20070090A

(51) Int. Cl. B60R 1/08; B60R 1/072; B60R 1/04

(52) U.S. Cl. 359/843; 359/877

(57) ABSTRACT

The rear-view mirror system for an automobile to eliminate driver blind spots comprises electrically controlled external side rear-view mirrors and an electrically controlled interior center rear-view mirror, and a control unit which rotates the external rear-view mirrors and moves and turns the interior center rear view mirror to provide a view of the blind spot. The system is activated either by the driver by a button press, or automatically upon initiation of a turn signal or upon turning of the steering wheel, and then automatically released to return the mirrors to their normal position after a predetermined length of time or upon completion of a turn.

### CROSS-REFERENCE TO RELATED APPLICATIONS

The present application is a continuation of pending International patent application PCT/HR2008/000006 filed on Mar. 4, 2008 which designates the United States and claims priority from Croatian patent application No. P20070090A filed on Mar. 6, 2007, the content of which is incorporated herein by reference.

### FIELD OF THE INVENTION

The present invention relates to the field of automotive rear view mirror systems, and elimination of “blind spot” areas, which are areas of partial views or of no view in the mirror system. Typically, the “blind spot” is located adjacent the rear pillars of the passenger compartment, and generally is the area that is not visible in the side view mirrors or the rear view mirror. In the present application the term “dead angle” refers to the area commonly known as the “blind spot.”

### BACKGROUND OF THE INVENTION

There have been many attempts to solve the dead angle problem in automobiles. US Patent Publication No. 20060167606 (Khaled Malhas), the disclosure of which is hereby incorporated by reference, describes a system of rotating side rear-view mirrors activated by pressing a button or by activation of vehicle direction indicators. Suggs, U.S. Patent Publication No. 20040252389, the disclosure of which is hereby incorporated by reference, discloses a similar system. These systems are only partially effective, as the rotation of the side mirrors to cover the dead angle creates new blind spots in areas that were previously covered by the side mirrors. Also, the disclosed systems require manual activation by the driver, who may not have hands free to activate the system during a lane change or other traffic maneuver.

### SUMMARY OF THE INVENTION

The present invention provides a system for covering the dead angle when the driver is checking it by moving all three rear-view mirrors of a car so that the driver's view field is focused on the area required in that specific situation; the movement of the three mirrors is controlled so that they are all automatically repositioned to provide the driver with the maximum rear and side view to eliminate the dead angle.

The present invention thus solves the technical problems of the prior art by providing an active rear-view mirror system in cars that eliminates dead angles and to enhances the driver's field of view in different driving conditions.

The vehicle shifting rear-view mirror system is implemented with aim to eliminate the dead angle, and comprises the external rear-view mirrors and the rear-view mirror located in the vehicle itself, a controlling unit of the system located in the car, where the shifts of the external rear-view mirrors are accomplished by shift of the mirror in both directions from the “zero” position around z axis which is vertical to the plain of the car, and the shift of the internal rear-view mirror is performed around both z axis in both directions and along the plain on which the center rear-view mirror is laying. The system also contains the control system which is provided with data concerning the control of the motors used for before mentioned shifting and turning so that the internal and external rear-view mirrors perform the previously defined movements, with the defined movement speed between two successive angles, where the final position of the rear-view mirrors depend on the parameters of the steering wheel turning angle, on the status of the direction indicators, and on the logic of the system which was activated by the driver.

### BRIEF DESCRIPTION OF THE DRAWINGS

FIG. 1A is a top, front and left side perspective view showing Automobile A having a conventional prior art rear view mirror system having a dead angle 5 with Truck B located in the dead angle and not being visible in the rear view mirror system.

FIG. 1B is a top and rear perspective view showing Automobile A having a conventional prior art rear view mirror system having a dead angle 5 with Automobile B located in the dead angle and not being visible in the rear view mirror system.

FIG. 2A is a top, front and left side perspective view showing Automobile A of FIG. 1A having a rear view mirror system in accordance with the invention having a very small dead angle 7 with Truck B being visible in the rear view mirror system.

FIG. 2B is a top and rear perspective view showing Automobile A Automobile A of FIG. 1A having a rear view mirror system in accordance with the invention having a very small dead angle 7 with Automobile B being visible in the rear view mirror system.

FIG. 3 is a top and rear perspective view showing Automobile C having a conventional prior art rear view mirror system having a dead angle with Automobile D located in the dead angle and not being visible in the rear view mirror system.

FIG. 4 is a top and rear perspective view showing Automobile E having a rear view mirror system in accordance with the invention having a displaced dead angle with Automobile F being visible in the rear view mirror system.

FIG. 5A is a top, front, and left side perspective view of a center mirror positioning system in accordance with the invention.

FIG. 5B is a top, front, and left side perspective view of the center mirror positioning system of FIG. 5A.

FIG. 6A shows a center mirror positioning system in accordance with the invention with the center mirror in a conventional driving position. FIG. 6A(1) is a top plan view of an automobile with a center mirror positioning system shown schematically;

FIG. 6A(2) is a left and rear elevation view of the center mirror positioning system showing the system from the position of a driver 23 in the automobile of FIG. 6A(1); and FIG. 6A(3) is a top, front, and left side perspective view of the center mirror positioning system in the position illustrated in FIGS. 6A(1) and 6A(2).

FIG. 6B shows a center mirror positioning system in accordance with the invention with the center mirror in a position to provide increased left side dead angle visibility. FIG. 6B(1) is a top plan view of an automobile with a center mirror positioning system shown schematically; FIG. 6B(2) is a left and rear elevation view of the center mirror positioning system showing the system from the position of a driver 23 in the automobile of FIG. 6B(1); and FIG. 6B(3) is a top, front, and left side perspective view of the center mirror positioning system in the position illustrated in FIGS. 6B(1) and 6B(2).

FIG. 6C shows a center mirror positioning system in accordance with the invention with the center mirror in a position to provide increased left side dead angle visibility. FIG. 6C(1) is a top plan view of an automobile with a center mirror positioning system shown schematically; FIG. 6C(2) is a left and rear elevation view of the center mirror positioning system showing the system from the position of a driver 23 in the automobile of FIG. 6C(1); and FIG. 6C(3) is a top, front, and left side perspective view of the center mirror positioning system in the position illustrated in FIGS. 6C(1) and 6C(2).

FIG. 7 is a graph which correlates the preferred speed of movement of the rear view mirror from its initial position to the end position (shown on the y axis) relative to the amount of movement or rotation of the rear view mirror (shown on the x axis).

FIG. 8 is a graph which correlates the preferred rotation or angle of the of the rear view mirror from its initial position (shown on the y axis) relative to the amount of rotation of the steering wheel (shown on the x axis) in one preferred embodiment of the automatic mode of the invention.

### DETAILED DESCRIPTION OF THE INVENTION

Changing lanes on a multilane road can be dangerous due to the problem of the dead angle. A driver before changing lanes checks his rear-view mirrors, but does not see adjacent vehicles. The driver could turn around and look over his shoulder but may neglect to do so because of distractions in the automobile such as passengers or mobile phone, or navigation equipments. The driver may simply not respect the need to be aware of adjacent vehicles.

Even if the dead angle is checked, there is still a high risk that the driver can oversee a vehicle or an object hidden by the dead angle. The problem is that if the driver wants to check the dead angle he must turn his head backwards. Therefore for a few seconds he does not see what is in front of his vehicle which posing other, potentially more significant risks. Many drivers can rely on their memory of oncoming vehicles to decide whether there is a vehicle in the dead angle but this may not yield a correct answer. Thus, wrong evaluation and inefficient checking of the dead angle is a recurring problem leading to numerous accidents, both large and small, in many roadways.

The system of active rear-view mirrors described here removes the dead angle without disturbing or adding tasks for the driver. The system can be activated in different ways: automatically or semi-automatically.

The automatic way of activation is linked to the turn signal indicator, and modulated by a rotation sensor on the steering wheel and information from the speedometer system.

The semi-automatic activation method is linked with the buttons on the vehicle steering wheel.

In the system of the present invention, the side rear-view mirrors are electrically actuated and controlled and are movable by rotating around a vertical z axis (if we take that x-y plain is parallel to the road, the z axis is vertical to it) clockwise and anticlockwise. The center rear-view mirror is movable sideways left and right, and at the same time it is simultaneously rotating with the side rear-view mirrors around the z axis. This complex movements of the center rear-view mirror located in the car reduces the dead angle.

The control system is operated as follows. The driver positions the external side rear-view mirrors either manually or using the electrical side mirror motor system using the standard side mirror control system. The position selected in this way is taken as a starting or a zero position and it is communicated to the central system, or the vehicle can just accept this position as a zero position. The center rear-view mirror is positioned either manually, or an electrical center rear view mirror motor system; this position is also taken as a standard or zero position and it is communicated to the central control system.

The maximum tilt of the external rear-view mirrors from the zero position is programmed between 7 degrees to 16 degrees, depending on the type of the vehicle. Maximal side shift of the center rear-view mirror from the zero position ranges, depending on the type of the vehicle, between 4 and 12 cm. The maximum rotation of the center rear-view mirror from the zero position ranges, depending on the type of the vehicle, between 6 degrees and 28 degrees. Of course, only the approximate values for easier understanding of the essence of the invention are mentioned here.

Semi-automatic Activation of the System: Two buttons are located on the steering wheel of the vehicle. One is located on the left and the other on the right side of the steering wheel. If the driver presses the left button, to provide rear view vision of the left side dead angle, then the left rear-view mirror will rotate around its z axis in the clockwise direction from its zero position to a preprogrammed left end position. At the same time the center rear-view mirror is moving sideways to the right and is rotating around the z axis clockwise until it reaches a preprogrammed final position. The right rear-view mirror is not moving. When the left and the center rear-view mirror reach their final position they remain fixed until the driver releases the button. When the driver releases the button the left rear-view mirror and the internal rear-view mirror immediately return to their initial position. If the driver releases the button before the rear-view mirrors reach their final position, then both rear-view mirrors immediately return to their initial position to provide the driver with the usual road view.

If the driver presses the right button to provide rear view vision of the right side dead angle, then the right rear-view mirror will rotate anticlockwise around the z axis from the zero position to a preprogrammed right end position. At the same time the center rear-view mirror is moving sideways to the left and is rotating around the z axis anticlockwise until it reaches a preprogrammed final position. The left rear-view mirror is not moving at all. When the right and the center rear-view mirror reach their final position they remain in that position until the driver releases the button. When the driver releases the button the right rear-view mirror and the internal rear-view mirror immediately return to their initial position. If the driver releases the button before the rear-view mirrors reach their final position, then both rear-view mirrors immediately return to their initial position to provide the driver with the usual road view.

Automatic Activation of the System: The system can be activated automatically either by the activation of the direction indicator or by rotation of the steering wheel; or by the activation of the direction indicator combined with rotation of the steering wheel.

Thus when activating the mechanism by turn signal indicator (also referred to herein as a direction indicator), the driver's activation of the left direction indicator activates the rear view mirror control system. The rear view mirror control system operates the left external rear-view mirror to rotate it clockwise around the z axis. The center rear-view mirror also rotates clockwise and shifts sideways on the right. The right rear-view mirror is not moved. Thus activated the center rear-view mirror and the left rear-view mirror shift and rotate to their final position. The rear-view mirrors keep their new position for some time so the driver has enough time to check the dead angle. The rear-view mirrors remain in the new position for 0.5 seconds up to 3 seconds, to give to the driver enough time to check the situation. If nothing further happens, the system returns the mirrors back to the initial position. However, if a sensor in the steering wheel detects that the driver moved to the next lane the rear-view mirrors immediately return to their initial position. The return of the rear-view mirrors to their initial position may be initiated after the steering wheel has been rotated in excess of 15 degrees in relation to the zero position of the steering wheel. The zero position of the wheel is defined by the position on which the steering wheel was in the moment when the direction indicators were activated. If at any moment the driver deactivates the direction indicators, the rear-view mirrors both external and internal ones are immediately returned to their initial position.

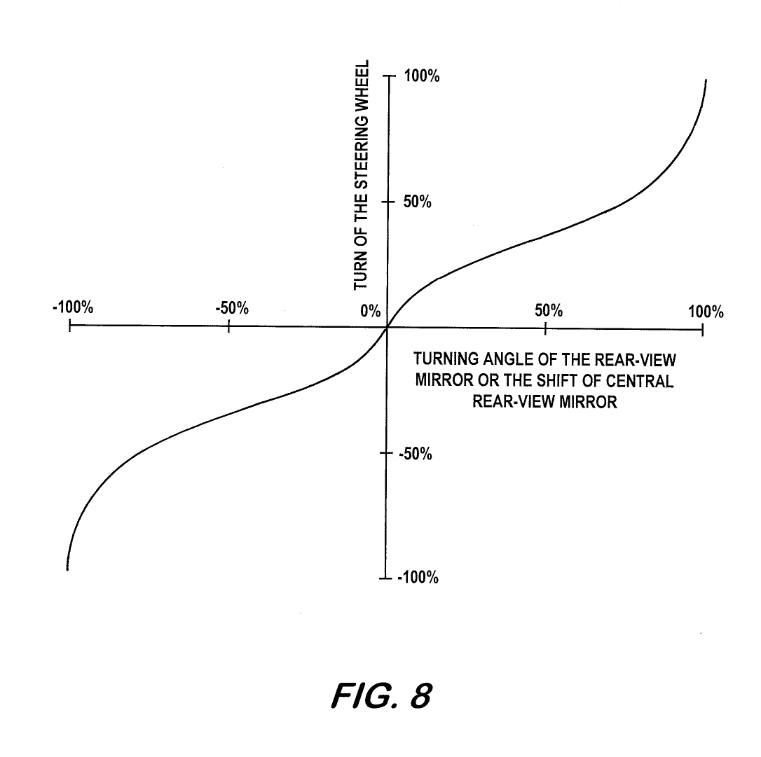

The activation by turning the steering wheel is especially important in curves where this system, if activated, can significantly help the driver. The rotation and the shift of the rear-view mirrors depend on the angle of rotation of the steering wheel, as it is represented on FIG. 8 and it is determined empirically for each car model. When the driver is going through a left curve the left external rear-view mirror rotates around its z axis clockwise to a certain empirically determined position. At the same time, the center rear-view mirror shifts right and rotates around its z axis clockwise to the predetermined position. The right rear-view mirror is not moving. When the driver is going through a right curve the right external rear-view mirror is going to rotate from its initial position around its z axis anticlockwise, while at the same time the center rear-view mirror is shifting to the left and rotating around its z axis in the same direction till it also reaches the empirically determined position which depends on the car model. The left rear-view mirror is not moving at all. Those actions are performed in continuation.

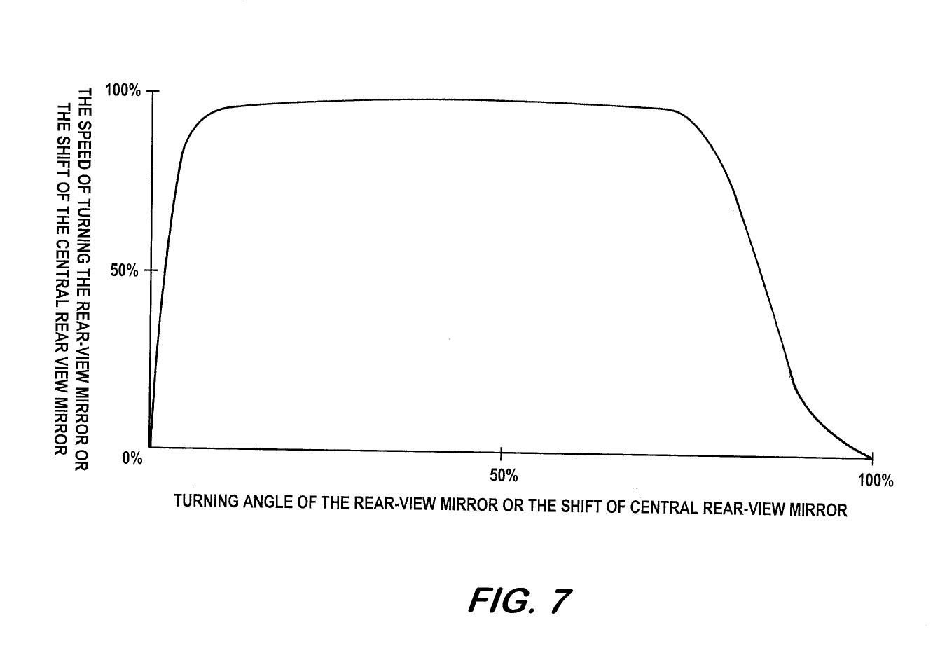

It is extremely important to mention that the left and right side rear-view mirrors, as also the center rear-view mirror, always turn and shift e.g. by a curve given on the FIG. 7 which is also empirically determined or calculated according to a certain algorithm. By the said graph, the shift and turn of the mirrors in the beginning are made at maximum speed and later the speed reduces as the mirror is getting closer to the final position and in this way it enables the driver to use the mirrors even while they change positions.

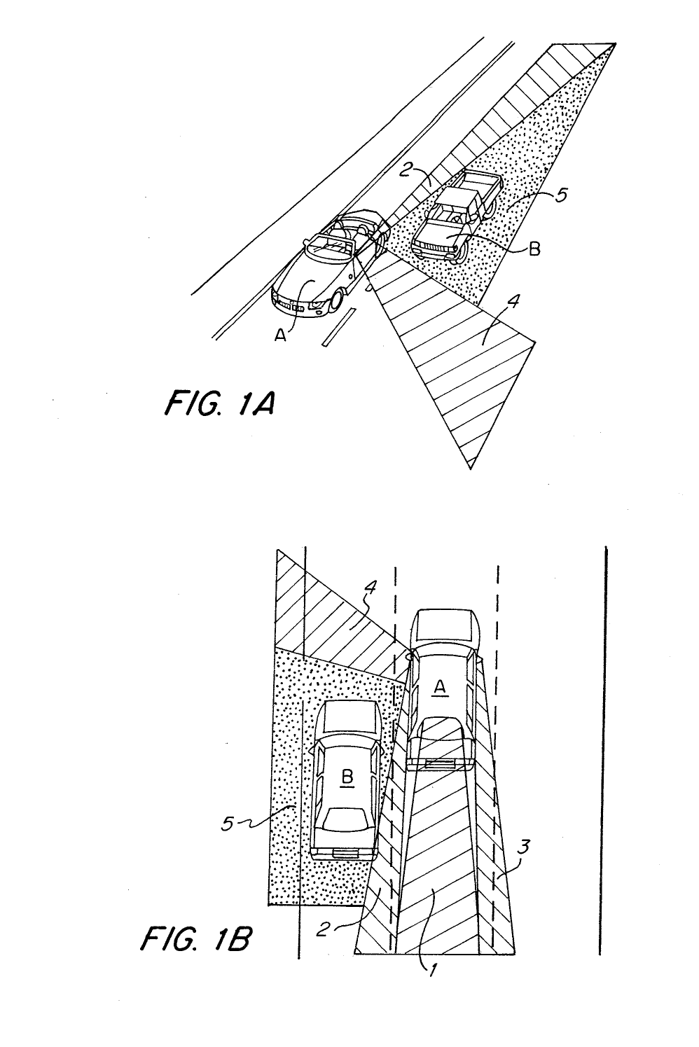

One of the possible ways how to implement the said invention is given by the figures. FIGS. 1A and 1B represent standard situations in which vehicles A and B drive in parallel in two adjacent lanes. To the driver of the vehicle A, the vehicle B is covered by the dead angle (5). The field of view (4) through the windshield and the field of view of the side rear-view mirrors (2) and (3) do not cover the dead angle (5). To the driver of the vehicle A, the vehicle B is completely covered by the dead angle. If in the said situation the driver of the vehicle A would like to get over to the lane on the left the accident is inevitable, because the driver of the vehicle A cannot see the vehicle B, of course the assumption here is that the vehicle B is relatively faster than the vehicle A.

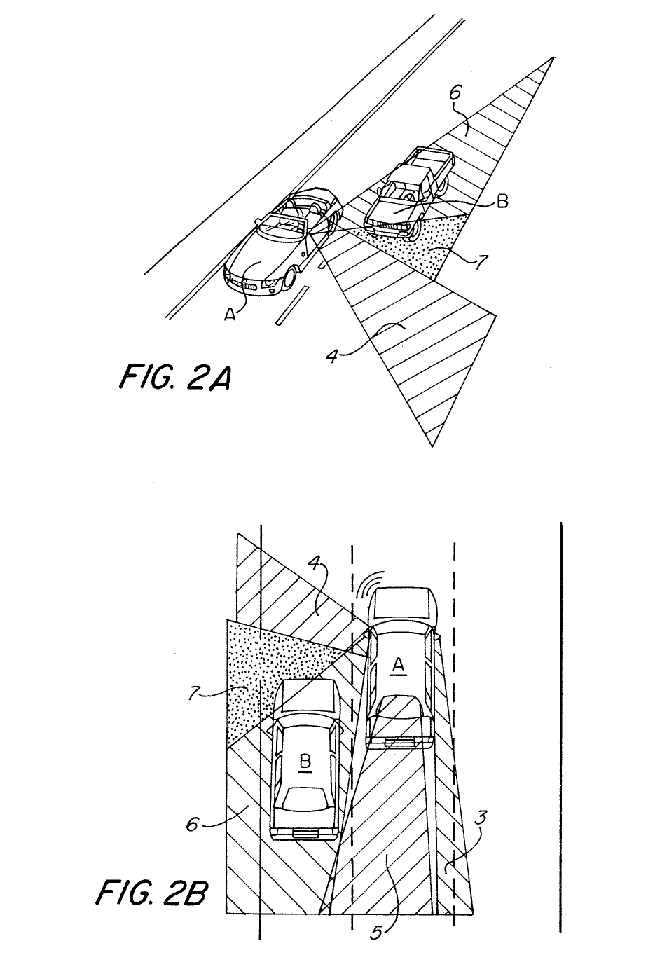

FIGS. 2A and 2B shows a vehicle A with the system of active rear-view mirrors in accordance with present invention. Before he changes lanes the driver of the vehicle A activates the left direction indicator and this activates the system of active rear-view mirrors. The left rear-view mirror is positioned so that the driver of the vehicle A can see the vehicle B. The center rear-view mirror also shifts its position so to cover with the view field (5) i.e. the area that remained uncovered when the left rear-view mirror shifted its position. Now the driver of the vehicle A can see the vehicle B in his field of view (6). In this situation the center rear-view mirror field of view (5) and the right rear-view mirror field of view (3) cover the remaining areas relevant for the driver. The dead angle (7) is reduced to a negligible area. When the driver of the vehicle A in his rear-view mirrors spots the vehicle B he is not going to change the lane anymore and he turns off the direction indicators, then the active rear-view mirror system returns the mirrors back to the starting position.

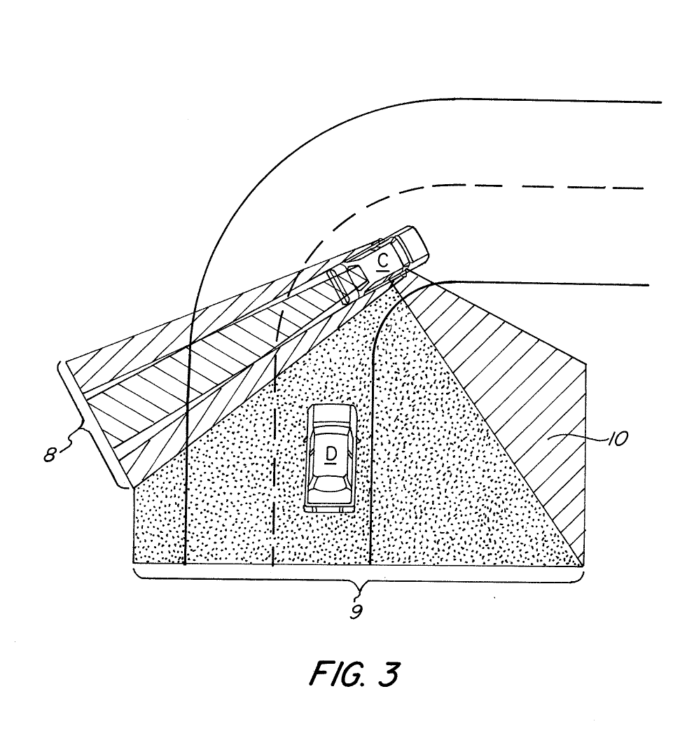

FIG. 3 shows a situation when the vehicle C with conventional rear-view mirrors enters a sharp right curve. The field of view (8) which has the driver of the vehicle when he looks in his rear-view mirrors is tangential to the trajectory of the car. In such a sharp curve conventional rear-view mirrors do not make possible to evaluate the traffic situation. The dead angle (9) in this situation is such that the driver of the vehicle C cannot see all the relevant areas, for example the vehicle D. The area (10) is the field of view for the driver of the vehicle C through the right front window.

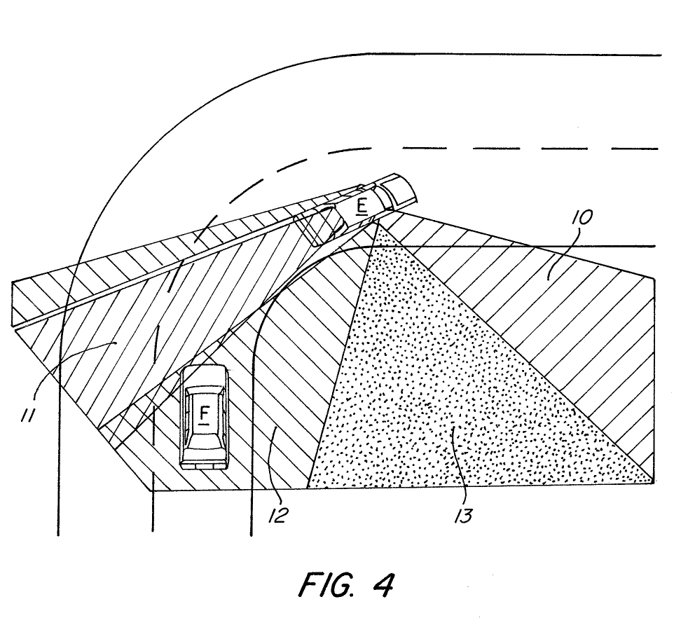

FIG. 4 shows a similar entrance to a sharp right curve as in FIG. 3. However, in FIG. 4, the vehicle E has an active rear-view mirror system in accordance with the present invention. The system registers the angle by which the steering wheel is turned, and depending on this angle and on the base of the speed of the vehicle determines the new position of the rear-view mirrors (see FIG. 8). The potential of the right rear-view mirror is used much more effectively than it is on the conventional rear-view mirror. With the active system of rear-view mirrors the driver of the vehicle E in the right rear-view mirror field of view (12) can see the whole curve. The center rear-view mirror is positioned to cover the area which disappeared from the vehicle E driver's field of view as the right rear-view mirror moved. The field of view of the center rear-view mirror (11) is also directed to the inner side of the curve. Therefore the dead angle (13) is reduced to such an extent that it no longer poses a threat.

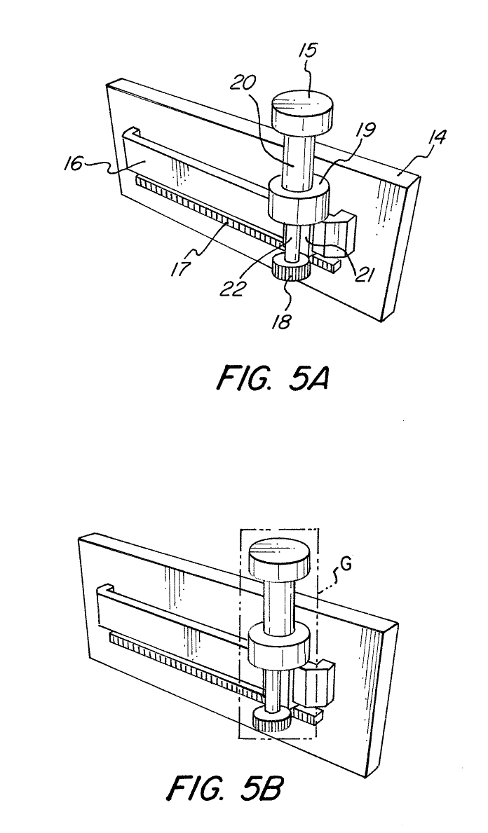

FIG. 5 shows a simplified example of the construction of the center rear-view mirror. The rear-view mirror is made of the frame with the mirror (14), electromotor (15) for turning around the z axis, electromotor for in line shifting movements (19), slide (16), rack (17), transmission gears (18), link (20) between the electromotor (15) and the slide (16), ring (21) for fixing of the slide (16) and mandrel (22) which is linking the gears (18) and the drive (19). The mentioned elements (15), (19), (20), (21), (22) and (18) are integrated in one unit G, while other elements (16), (17) and (14) are part of a movable unit. The unit G is attached to a fix point in a car, e.g. window or the roof of the car, and therefore it does not move in relation to the car.

The system for shifting and turning of the side rear-view mirrors is known to the present state of technology, therefore for the implementation of this invention any commercially available system which can be found on the market, and which makes possible to rotate the mirrors around the previously mentioned z axis, can be used.

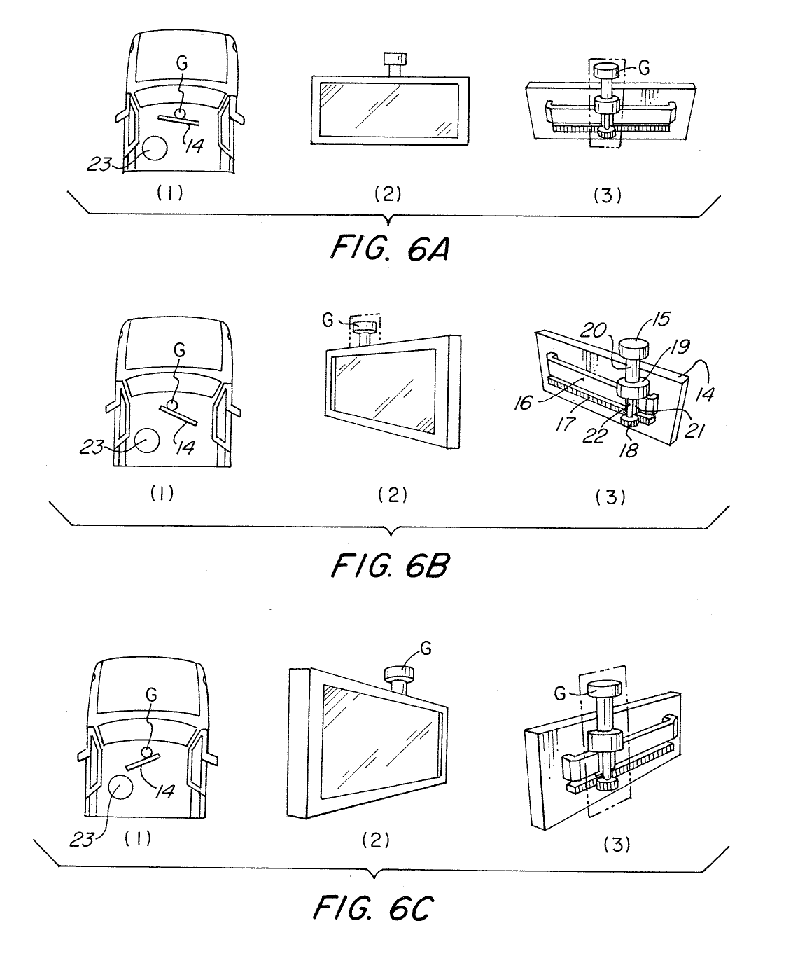

FIGS. 6A, 6B, and 6C show three possible situations where the center rear-view mirror is in different positions. In FIG. 6A the presumption is that the car is moving in a straight line. The center rear-view mirror is in standard “zero” position.

FIG. 6B shows the situation when the car goes through the left curve or when changing lanes to the left. In this situation the frame of the rear-view mirror (14) shifts, from the driver prospective (23) to the right and turns clockwise around the z axis of the G point. FIG. 6C shows the situation where a car goes through a right turn or is changing lanes to the right. In this situation the frame of the rear-view mirror (14) shifts, from the driver prospective (23) to the left and turns anticlockwise around the z axis of the G point.

FIG. 7 on the y axis shows the speed of turning the rear-view mirror (or the shift of the center rear-view mirror) in function of the turning angle of said rear-view mirrors and it is represented along the x axis. From the exposed materials we can see the speed of shifting rear-view mirrors is small for very small and also for very large turns, while the speed for the remaining turning angles is—maximum possible—and is determined by the specifications of the electromotor and its transmission rates.

FIG. 8 on the y axis shows the turn of the steering wheel in percentage points “+” or “−” 100%. The x axis indicates an example of empirically determined functional dependency of turn (or shift) of the center rear-view mirror and side rear-view mirrors from the zero position in dependence of the turning of the steering wheel.

Here also it is necessary to mention that the electronic circuits which take care of the logic, shifts and position of the rear-view mirrors will preferably be implemented through a digital control system and stepping motors, which unconditionally follow the commands previously stored in the memory of the hardware controllers, where those controllers control the peripheral motors for shifting of rear-view mirrors. Of course, each car model is managing its own rear-view mirrors in a specific way, especially as thus it is possible to optimise the efficiency in which the design of the vehicle is used.

The industrial application of the invention is on automobiles and other vehicles where the design of their window surfaces can be enhanced to their maximum if the invention for reducing or complete removal of the dead angle is implemented.

What is claimed is:

1. A rear-view mirror system for an automobile providing visibility in a driver blind spot, comprising:
an electrically actuated remotely controlled external left side rear-view mirror;
an electrically actuated remotely controlled external right side rear-view mirror;
an electrically actuated remotely controlled interior center rear-view mirror;
a control unit operable to position the external left side rear-view mirror, external right side rear-view mirror, and the interior center rear-view mirror in a default position; said control unit being operable to position the external left side rear-view mirror and the interior center rear-view mirror in a left blind spot viewing position; said control unit being operable to position the external right side rear-view mirror and the interior center rear-view mirror in a right blind spot viewing position.

2. The rear-view mirror system of claim 1, wherein the electrically actuated remotely controlled interior center rear-view mirror has a mirror surface which is rotated and moved sideways.

3. The rear-view mirror system of claim 2, wherein the electrically actuated remotely controlled interior center rear-view mirror rotates and moves the mirror surface to a predetermined left blind spot viewing position when actuated for left blind spot viewing, or to a predetermined right blind spot viewing position when actuated for right blind spot viewing.

4. The rear-view mirror system of claim 3, wherein the electrically actuated remotely controlled external left side rear-view mirror and the electrically actuated remotely controlled interior center rear-view mirror simultaneously rotate in a clockwise direction to predetermined left blind spot viewing positions.

5. The rear-view mirror system of claim 3, wherein the electrically actuated remotely controlled external right side rear-view mirror and the electrically actuated remotely controlled interior center rear-view mirror simultaneously rotate in a counterclockwise direction to predetermined right blind spot viewing positions.

6. The rear view mirror system of claim 4 having a left blind spot mirror system actuator associated with a driver's steering wheel to activate the rear view mirror system to the left blind spot viewing position by driver activation.

7. The rear view mirror system of claim 4 having a right blind spot mirror system actuator associated with a driver's steering wheel to activate the rear view mirror system to the right blind spot viewing position by driver activation.

8. The rear view mirror system of claim 6 which is released and the mirrors are positioned in the default position upon release of the left blind spot mirror system actuator by the driver.

9. The rear view mirror system of claim 7 which is released and the mirrors are positioned in the default position upon release of the right blind spot mirror system actuator by the driver.

10. The rear view mirror system of claim 4 having a left blind spot mirror actuation means automatically activated by operation of the left turn signal, activation of said left blind spot mirror actuation means causing said external left side rear-view mirror and the interior center rear-view mirror to rotate to their predetermined left blind spot viewing positions.

11. The rear view mirror system of claim 10, wherein the left blind spot mirror actuation means returns the external left side rear-view mirror and the interior center rear-view mirror to their default positions after a predetermined time period.

12. The rear view mirror system of claim 11, wherein the left blind spot mirror actuation means returns the external left side rear-view mirror and the interior center rear-view mirror to their default positions after 0.5 seconds to 3 seconds.

13. The rear view mirror system of claim 10, wherein the left blind spot mirror actuation means returns the external left side rear-view mirror and the interior center rear-view mirror to their default positions after a steering wheel sensor detects a predetermined rotation of the steering wheel.

14. The rear view mirror system of claim 13, wherein the left blind spot mirror actuation means returns the external left side rear-view mirror and the interior center rear-view mirror to their default positions after a steering wheel sensor detects a rotation of the steering wheel of 15 degrees or more.

15. The rear view mirror system of claim 5 having a right blind spot mirror actuation means automatically activated by operation of the right turn signal, activation of said right blind spot mirror actuation means causing said external right side rear-view mirror and the interior center rear-view mirror to rotate to their predetermined right blind spot viewing positions.

16. The rear view mirror system of claim 15, wherein the right blind spot mirror actuation means returns the external right side rear-view mirror and the interior center rear-view mirror to their default positions after a predetermined time period.

17. The rear view mirror system of claim 16, wherein the right blind spot mirror actuation means returns the external right side rear-view mirror and the interior center rear-view mirror to their default positions after 0.5 seconds to 3 seconds.

18. The rear view mirror system of claim 15, wherein the right blind spot mirror actuation means returns the external right side rear-view mirror and the interior center rear-view mirror to their default positions after a steering wheel sensor detects a predetermined rotation of the steering wheel.

19. The rear view mirror system of claim 18, wherein the right blind spot mirror actuation means returns the external right side rear-view mirror and the interior center rear-view mirror to their default positions after a steering wheel sensor detects a rotation of the steering wheel of 15 degrees or more.
